(19) United States
(12) Patent Application Publication
(10) Pub. No.: US 2008/0107092 A1
(43) Pub. Date: May 8, 2008

(54) Universal services interface for wireless broadband networks

(76) Inventors: Pouya Taaghol, San Jose, CA (US); Muthaiah Venkatachalam, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/648,179

(22) Filed: Dec. 29, 2006

Related U.S. Application Data
(60) Provisional application No. 60/858,194, filed on Nov. 8, 2006.

(51) Int. Cl. H04Q 7/24

(52) U.S. Cl. 370/338

(57) ABSTRACT

Embodiment of the invention relate to a new type of service interface network node which enables a service provider of a broadband wireless access (BWA) network to provide relevant information to application service provider (ASPs) in a public Internet and in turn allows ASPs to provide value add services or enhanced experience to mobile users in the network. Value add services may include content involving quality-of-service (Qos) IP flows such as Internet Protocol (IP) television (IPTV) as well as location-based service content such as location relevant searches or directions. Additional embodiments and variations are also disclosed.

### CROSS-REFERENCE TO RELATED APPLICATIONS

This application claims priority under 35 U.S.C. § 119e to co-pending U.S. application Ser. No. 60/858,194 entitled Universal Services Interface and filed by the instant inventors on Nov. 8, 2006.

### BACKGROUND OF THE INVENTION

There is ongoing interest in developing and deploying mobile networks which may facilitate transfer of information at broadband bandwidth and rates. These networks are colloquially referred to herein as broadband wireless access (BWA) networks and may include networks operating in conformance with one or more protocols specified by the 3^{rd} Generation Partnership Project (3GPP) and its derivatives or the Institute for Electrical and Electronic Engineers (IEEE) 802.16 standards (e.g., IEEE 802.16-2005) although the embodiments discussed herein are not necessarily so limited. IEEE 802.16 compliant BWA networks are sometimes referred to as WiMAX networks, an acronym that stands for Worldwide Interoperability for Microwave Access, which is a certification mark for products that pass conformity and interoperability tests for the IEEE 802.16 standards

Service providers have been looking for a technology that enables convergence of the service layer, such that value-add services, which can be easily deployed. To fill this gap, the mobile industry (more specifically the 3^{rd} Generation Partnership Project (3GPP)) has created a comprehensive all-IP network named Internet Protocol (IP) Multimedia Subsystem (IMS). The promise of convergence by IMS is being weighed against its complexity both on the network side and the client device side. This has led the industry to question suitability of IMS as a convergence technology of choice.

In modeling the deployment and implementation of WiMAX networks, there are ongoing questions on how to best integrate cooperation between service providers (SPs), which are the providers that operate network infrastructure and provide wireless access to subscribers, and Internet Application Service providers (IASPs) (e.g., GOOGLE®, YAHOO®, etc.), which are providers that offer aggregated content on the public Internet Protocol (IP) networks including content providers (CPs) and/or Internet advertisers (IAs).

### BRIEF DESCRIPTION OF THE DRAWING

Aspects, features and advantages of the present invention will become apparent from the following description of the invention in reference to the appended drawing in which like numerals denote like elements and in which:

FIG. 1 is functional block diagram of a network architecture according to various inventive embodiments;

FIG. 2 is a signaling diagram for providing universal services interface (USI) proxy registration according to one aspect of the invention;

FIG. 3 is a signaling diagram for setting up a USI quality-of-service (QoS)-Based IP Flow Session according to various aspects of the invention;

FIG. 4 is a signaling diagram for terminating a USI QoS-Based IP flow according to various aspects of the invention; and

FIG. 5 is a signaling diagram for providing location based services (LBS) via a USI according to further aspects of the invention.

### DETAILED DESCRIPTION OF THE INVENTION

While the following detailed description may describe example embodiments of the present invention in relation to networks utilizing orthogonal frequency division multiplexing (OFDM) or Orthogonal Frequency Division Multiple Access (OFDMA) modulation, the embodiments of present invention are not limited thereto and, for example, can be implemented using other multi-carrier or single carrier spread spectrum techniques such as direct sequence spread spectrum (DSSS), frequency hopping spread spectrum (FHSS), code division multiple access (CDMA) and others as well as hybrid combinations of such protocols. While example embodiments are described herein in relation to wireless metropolitan area networks (WMANs) such as WiMAX networks, the invention is not limited thereto and can be applied to other types of wireless networks where similar advantages may be obtained. Such networks specifically include, but are not limited to, wireless local area networks (WLANs), wireless personal area networks (WPANs) and/or wireless wide area networks (WWANs) such as cellular networks and the like.

There are two general models which are generally known to provide integration between SPs and IASPs including: (i) the old cellular or “walled garden” model in which content is provided entirely through SP's control environments; and (ii) the open model in which content is provided by IASP transparently via the SP.

The walled garden model had advantages for the SP in that it had full control on content accessed by the user. However the limited content typically provided by the SPs was incomparable with those of Internet, and thus failed to attract widespread user interest.

The open model is attractive to users because it may provide nearly unlimited content. However, because the SP is transparent to transactions in this model, there is no revenue opportunity for the SP beyond access usage. Furthermore, because mobile station location is not known by the IASPs, without some input from SPs, there are limits on enhanced services which may be provided.

Thus according to certain embodiments of the present invention, a new model of content solutions for wireless broadband networks is defined in which improved content may be provided by IASPs with the SP's assistance. This model is referred to herein as the universal services interface (USI) model or Internet+ model. The USI model proposed herein is beneficial to users, IASPs and SPs in that users may obtain a wider variety of content than previously available, SPs can benefit from additional revenue sharing, and IASPs can offer better, more convenient, and/or smarter services to users.

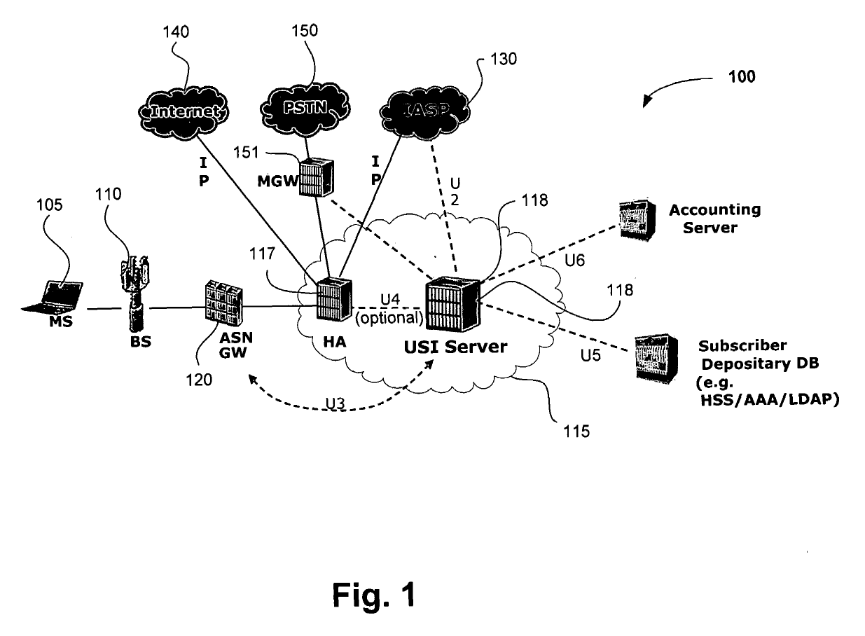

Turning to FIG. 1, an example network architecture 100 for implementing the USI model is shown. According to one exemplary implementation, a mobile station (MS) 105, for example subscriber stations using protocols compatible with the IEEE) 802.16 standards (e.g., IEEE 802.16-2005 Amendment), may communicate via an over-the-air (OTA) interface with a base station (BS) 110 to connect with a connectivity service network (CSN) 115 operated by a service provider.

In certain example implementations, communications between subscribers via BS 110 to CSN 115 may be facilitated via one or more access service network gateways (ASNGW) 120 although the inventive embodiments are not limited to this specific type of network implementation. ASNGW 120 (or other similar type of network node) acts as an interface between core network 115 and a plurality of base stations 110 and may function as a type of BS controller and/or mobile switching center (MSC) to facilitate handover control and other functions for a radio access network (RAN), although the embodiments are not so limited.

Connectivity service network (CSN) 115, in certain example embodiments, may include a home agent (HA) 117 (or similar type of network node) and a new type of network node referred to herein as a USI Server 118 which acts as a gateway for the interaction with the application service provider (IASP) 130 such as GOOGLE®, etc. Home agent 117 may serve as a seamless Internet Protocol (IP) traffic hub to connect mobile stations (e.g., MS 105) with other non-service provider networks or entities such as a public Internet network 140, a public switched telephone network (PSTN) 150 and/or IASP 130. In actuality, IASP 130 may be part of Internet network 140 but is shown separately in FIG. 1 to highlight various interactions with the service provider's CSN 115. If desired, a media gateway (MGW) node 151 may be used to convert circuit-switched communications to IP communications or vice versa between home agent 117 and PSTN 150 although the inventive embodiments are not limited in this respect.

According to certain embodiments, an accounting server 160 and/or subscriber depository database 170 may also be included in network 100. Accounting server 160 may be coupled with service provider's CSN 115 to authenticate/track user subscriptions (e.g., to track user charges) while database 170 may be used to store customer profiles and/or personal data and preferences of subscribers (e.g., to identify users and authorized services). In certain embodiments sever 160 and database 170 may be combine in a single node. To this end, the description and illustration of network 100 represents logical entities and thus arrangements of certain entities could be combined with others or separated from one another according to network design preference and/or physical constraints.

According to the example network architecture in FIG. 1, the key logical interfaces for network 100 are as follows:
U2 interface: between the IASP 130 and the USI server 118;
U3 interface; between the ASN 120 and the USI server 118; and
U4 interface; an optional interface between HA 117 and the USI server 118.

USI Server 118 may also have interfaces U6 to accounting server 160 and U5 to subscriber depository DB 170 for content charging records and/or service authorization and user privilege.

According to certain inventive embodiments the U2 interface between IASP 130 and USI server 118 may be used primarily for user identification (e.g., user of mobile station 105) as well as any other interaction described herein between the service provider network and the IASP 130.

The U3 interface between USI server 118 and ASNGW 120 is a signaling and hotlining interface which in certain embodiments may support functions for location services, presence, provisioning, etc.

Location services: upon the association of MS 105 with a new serving gateway (SGW) (e.g., anchor paging controller (APC) or ASN-GW 120), either via inter-ASN handover or anchor PC relocation, the new SGW handshakes with USI server 118 via U3 to inform the change in the SGW for MS 105. When accurate location of MS 105 is requested by a content provider (e.g., IASP 130), USI 118 may contact the SGW to begin location measurements.

Presence: when MS 105 performs network entry/exit or idle mode entry/exit, in a particular ASN-GW, the GW handshakes with USI server 118 via U3 to convey presence (or lack thereof information.

Provisioning: if USI server 118 also functions as a provisioning server, U3 can be used for signaling of provisioning operations (e.g., Provisioning start, Provisioning complete, etc.). Additionally, MS 105 can be hot-lined to USI server 118 via U3 until provisioning is complete.

In certain embodiments, an optional U4 interface may be used for quality-of-service (QoS) signaling between home agent 117 and USI 118 for managed QoS services like IP television (IPTV). In other embodiments, U4 is omitted and the foregoing signaling may be conveyed directly to ASN-GW 120 via the U3 interface.

Managed QoS Service Illustration via USI:

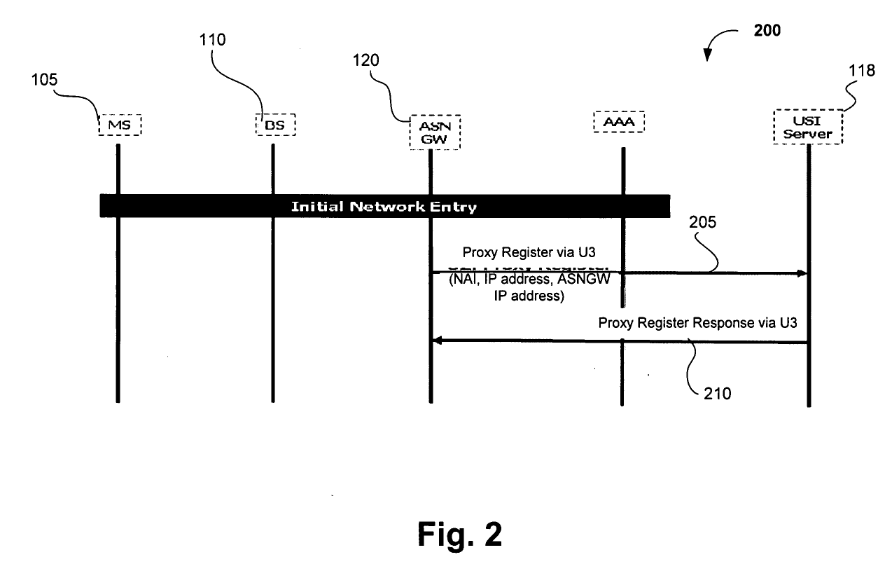

Turning to FIG. 2, in various embodiments, mobile station 105 may register with USI sever 118 via a proxy process 200. ASN Gateway 120 may decide based on a policy received during authentication and network entry process (e.g. via an AAA accept message) if registration to USI server 118 is required (for example if a user is subscribed to the service), in which case a registration message 205 may be sent by ASN Gateway 120 to USI Server 118. In one example embodiment, registration message 205 may include information for USI server 118 to identify MS's 105 HoA address, service location controller (LC) address (e.g., ASN-GW IP address), user identity (e.g., network access identification (NAI)), and/or device identification (e.g., medium access control (MAC) IP address, if desired). In turn, a proxy registration response 210 may be returned by USI server and USI registration is complete.

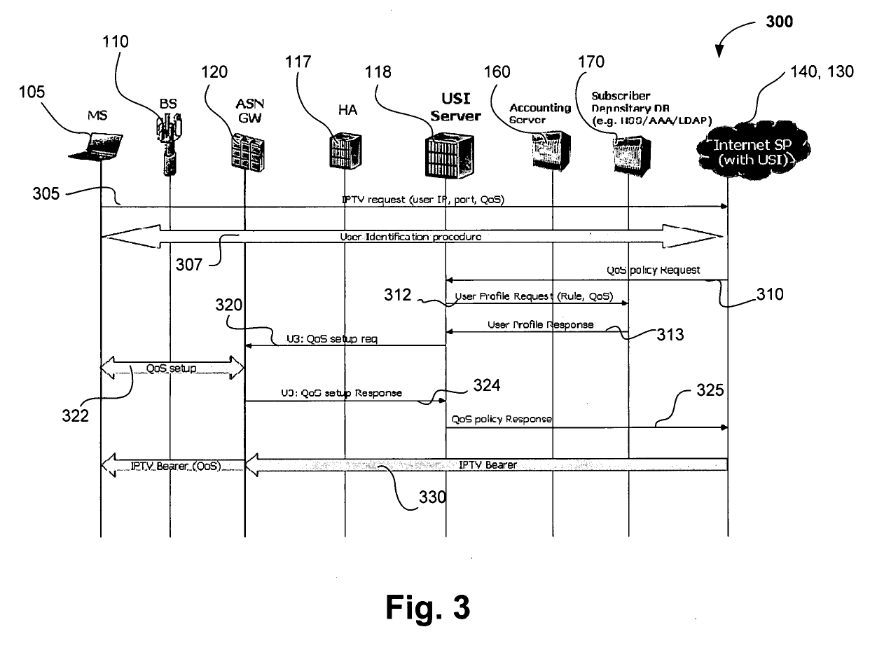

Referring to FIG. 3, an example signaling process 300 is described for setting up a USI QoS-based IP flow with mobile station 105 and IASP 130. By way of example, process 300 may be triggered by a user accessing a particular content of IASP 130 that may require QoS provisioning over the radio channel or link between mobile station 105 and base station 110 (FIG. 1). For example, MS 105 sends an IPTV request 305 to IASP 130 which may include the MS IP address, port and QoS request. In this case, IASP 130 may contact USI sever 118 requesting 310 QoS reservation for MS 105.

The user/MS 105 may be known to IASP 130 by its IP address and/or the user IP address can be mapped to the user's potential other identities known to USI Sever 118 via the USI Proxy Registration described in FIG. 2. USI server 118 may determine whether the user is authorized for the requested QoS-based service and/or track charges related to the requested service via signaling (e.g., 312, 313) with subscriber DB 170 and/or signaling (not shown) with accounting server 160. After the authorization of the required QoS has been determined, USI server 118 requests for QoS allocation in the radio network, the radio link to MS 105 having the required QoS parameters is set up and the IASP 130 is informed to proceed with the QoS-IP flow, for example via example signaling 320, 322, 324 and 325 between entities shown in FIG. 3. IASP 130 may then begin the QoS-IP service flow 330 with MS 105 directly via the radio network (e.g. a WiMAX network) via home agent 117, ASN-GW 120 and BS 110 without requiring further participation from, or exclusive of, USI server 118.

As shown in FIG. 3, a user identification procedure 307 may be used in which IASP 130 may identify the user's IP address and its Service Provider's USI Server. Examples of such an identification procedure could include:

(i) Known SP's IP Subnet: The IASP knows Service Provider's IP subnet. Once the user accesses the IASP contents, the IASP can identify the user's SP from the user's IP subnet. Using a look up table, the USI Server of that SP is identified;

(ii) User Login to IASP: In the process of login (or using cookies), the user's public NAI becomes known to IASP. The realm part of NAI includes information about the user's SP which can be used to retrieve USI Server IP address; and/or

(iii) User Identifies Its SP & ID to IASP: Through WebServices (e.g., JavaScript, CGI) or proprietary interfaces.

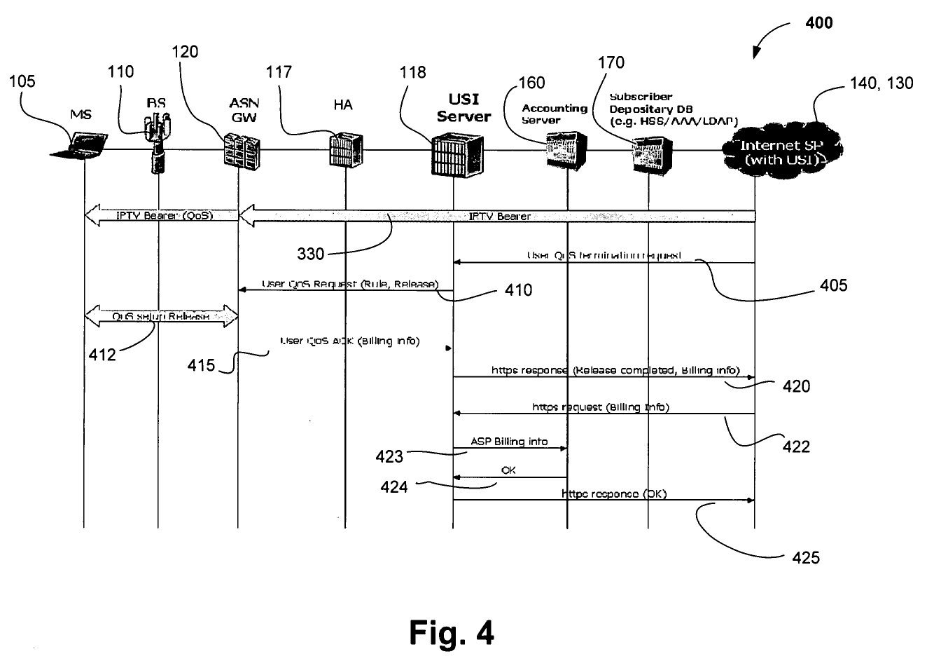

Referring to FIG. 4, once the QoS service session between IASP 130 and MS 105 is complete, IASP 130 may request termination of the QoS-based flow 330 by signaling 405 USI server 118 which may in turn signal 410 the radio access network to release 412 or end the QoS radio link resources used for the QoS-based flow with MS 105. Various signaling, e.g., signaling 415, 420, 422, 423, 424 and 425, may then be performed by the network entities to confirm the release of the QoS resources and, if desired, establish charging and accounting information for storage by accounting server 160 as shown in FIG. 4.

It should be recognized that the signaling examples and network entities described with reference to FIGS. 1-4 may vary significantly depending on the type of network utilized and preference of network designers. Accordingly, the foregoing signaling and entities are only presented as illustrative examples for potential implementation of the inventive embodiments. A general focus of the foregoing inventive embodiments is that the broadband wireless access network operator (or service provider) may provide relevant information to Internet application service providers (IASPs), which can in turn be used by the IASPs to provide value add services or enhanced experience to the end user. Some examples of the value add services are described below.

Location Based Services via USI Example:

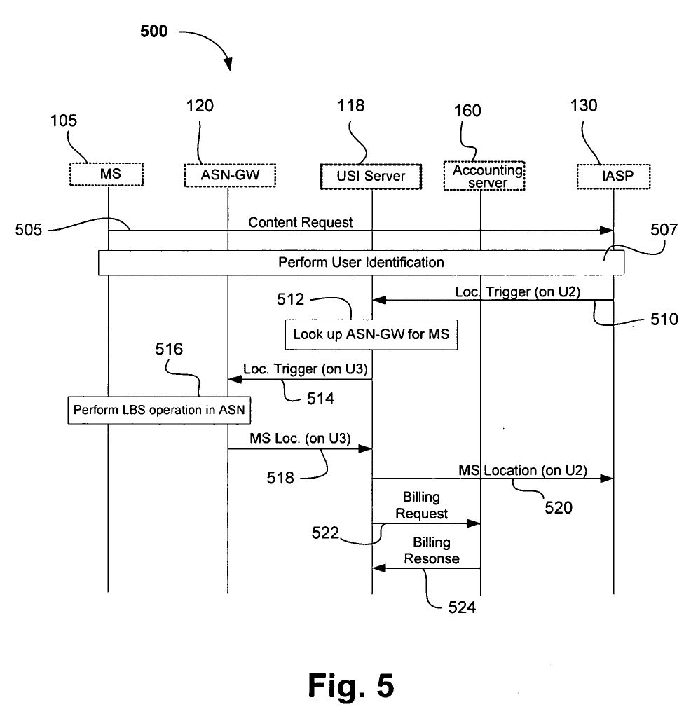

Turning to FIG. 5, an example process 500 may be used by IASPs (e.g., IASP 130) to get the location of a mobile user in a WiMAX network and use this location to provide value add services such as: (i) web searches for businesses local to the user; (ii) mapping and directions for the user in the event that the user is lost and does not know his current address; or (iii) other types of location based services offered by IASPs. Process 500 may include a mobile station requesting 505 location-based service (LBS) content, such as driving directions from its present location, from Internet application service provider 130.

In response, IASP 130 may identify 507 the requesting user using a method such as any of the methods discussed previously, and contact 510 the appropriate USI server 118, via interface U2 (FIG. 1) to discover the present location of the mobile user 105. USI server 118 may in turn determine 512 which access service network gateway (or other radio access network node which may control MS handover/MS tracking) is currently serving MS 105 and signal 514 the appropriate ASN-GW 120 to perform 516 a location determination for MS 105 (if it is not already known). The location of MS 105 may then be signaled 518, 520 back to IASP 130 so that the requested LBS content may be provided (this IP-traffic flow is not separately shown in FIG. 5).

In certain embodiments, if desired, the service provider operating USI server 118, may update subscriber charges or billings (which may include service fees for the SP and/or IASP) for the requested LBS service(s) with accounting server 160, e.g., via signaling 522 and 524.

In contrast to the conventional IMS (IP Multimedia System), the USI solution is far more simplified and easier to implement (e.g., fewer nodes, simpler protocols, etc.). According to certain embodiments of the invention, a signaling protocol for secure multimedia session control may use extensible Markup Language (XML) exchanges over Hypertext Transfer Protocol Secure sockets (HTTPS). In comparison with traditional Session Initiation Protocol (SIP) used in the IMS framework, the proposed scheme (XML/HTTPS) may have the following advantages:
HTTPS is an absolute commodity in notebooks and handhelds
Guaranteed interoperability
Built in security
Enables push and pull models
Can easily integrate to web applications to create value-add services
Resistant to MS IP address changes
Transport layer independence (NAT/NAPT, IPv4/6)
Session Initiated Protocol (SIP) is not a commodity in devices and thus interoperability is not guaranteed by the IMS framework.

In embodiments of the present invention discussed herein, the Universal Services Interface (USI) model is a simple, flexible, Internet-friendly solution that enables service providers to sell value-add services by interfacing to content providers. Some examples of value add services include but are not limited to: (i) location based searches for local business; (ii) location aware mapping service; and (iii) high quality IPTV service via managed QoS.

Unless contrary to physical possibility, the inventors envision the embodiments described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network, the method comprising:
receiving a request for communication services from an application service provider (ASP) associated with a public Internet Protocol (IP) network;
signaling a radio access network (RAN) node to perform an operation relating to a mobile user in response to the request; and
informing the ASP of the performed operation.

2. The method of claim 1 wherein the request for communication services comprises a quality of service (QoS) request from the ASP to provide a QoS-based IP traffic flow to the mobile user and wherein the operation comprises adapting a radio link with the mobile user to support the requested QoS-based IP traffic flow.

3. The method of claim 1 wherein the request for communication services comprises a location query to identify a geographical position of the mobile user to enable the ASP to provide location-based content to the mobile user.

4. The method of claim 1 wherein the RAN node comprises an access service network gateway (ASN-GW) node.

5. The method of claim 1 further comprising:
signaling an accounting server to charge the mobile user for the requested communication services.

6. The method of claim 1 wherein after receiving the request, the method further comprises:
signaling a subscriber database to inquire whether the mobile user is authorized for the communication services requested by the ASP.

7. The method of claim 1 wherein the RAN node is part of a broadband wireless access (BWA) network.

8. The method of claim 7 wherein the BWA network uses protocols compatible with the Institute of Electrical and Electronic Engineers (IEEE) 802.16-2005 standard.

9. The method of claim 2 wherein the request is received via a first interface and wherein the QoS-based IP traffic flow is sent to the mobile user exclusive of the first interface.

10. A method of providing content to mobile users of a wireless network, the method comprising:
receiving a request for content via a first interface from a mobile station in a radio access network (RAN);
sending, via a second interface exclusive of the first interface, a communication service request to a service provider node of the RAN;
receiving information regarding the requested communication service via the first interface; and
providing the requested content to the mobile station via the first interface.

11. The method of claim 10 wherein the communication service request comprises a quality of service (QoS) request to adapt an over-the-air (OTA) link with the mobile station to a QoS level supporting the requested content.

12. The method of claim 10 wherein the request for content includes a request for location-based service and wherein the communication service request comprises a request to identify a location of the mobile station.

13. The method of claim 10 wherein after receiving the request for content, the method further comprises, identifying the mobile station and the service provider node to send the communication service request.

14. The method of claim 10 wherein at least a portion of the RAN comprises a broadband wireless access (BWA) network.

15. A system for providing wireless communication, the system comprising:
a service interface node configured to communicate with one or more radio access network (RAN) nodes via a first interface and communicate via a second interface, exclusive of the first interface, with one or more application service providers (ASPs) of a public Internet Protocol (IP) network, wherein the service interface node is further configured to perform at least one of: (i) initiating a QoS-level radio link between a RAN node and a mobile station via the first interface in response to a request received from an ASP via the second interface; or (ii) provide mobile station location information to an ASP via the second interface to enable the ASP to provide location-relevant content to the mobile station.

16. The system of claim 15 wherein the service interface node is further configured to communicate with an accounting server via a third interface to account charges to a subscriber associated with the mobile station in response to initiating the QoS-level radio link or providing the mobile station location information.

17. The system of claim 15 wherein the service interface node is further configured to communicate with a subscriber database to identify whether the mobile station is authorized to receive the QoS-level radio link or location-relevant content.

18. The system of claim 15 wherein the one or more RAN nodes comprise network nodes in a broadband wireless access (BWA) network.

19. The system of claim 15 further comprising a home agent node coupled to the public IP network and wherein content is provided between the ASP and the mobile station via the home agent node, exclusive of the service interface node.

20. The system of claim 15 further comprising at least two RAN network nodes including an access service network gateway (ASN-GW) nodes and at least one base station node coupled with the ASN-GW to facilitate with radio link with the mobile station.

21. The system of claim 18 wherein the at least one base station node includes a transceiver and a plurality of antennas, the base station node adapted to use multiple-input multiple-output communication techniques.

22. The system of claim 18 wherein the at least one base station nodes uses modulation protocols compatible with an Institute of Electrical and Electronics Engineers (IEEE) 802.16-2005 standard.
